(19) United States
(12) Patent Application Publication
(10) Pub. No.: US 2025/0041651 A1
(43) Pub. Date: Feb. 6, 2025

(54) Exercise Bike Flywheel System

(71) Applicant: Huan-Yu Cheng, Taipei (TW)

(72) Inventor: Huan-Yu Cheng, Taipei (TW)

(21) Appl. No.: 18/586,653

(22) Filed: Feb. 26, 2024

(30) Foreign Application Priority Data
Aug. 1, 2023 (CN) 202322047031X

(51) Int. Cl. A63B 21/22; A63B 21/00; A63B 21/005; A63B 22/06; A63B 24/00; H02K 7/02; H02K 7/102; H02K 7/116; H02K 11/22

(52) U.S. Cl. CPC A63B 21/225; A63B 21/0056; A63B 21/0058; A63B 21/15; A63B 22/0605; A63B 24/0062; H02K 7/02; H02K 7/102; H02K 7/116; H02K 11/22; A63B 2220/24; A63B 2220/833

(57) ABSTRACT

An exercise bike flywheel system includes a rotating shaft, a flywheel, one or more brake components, a bracket, first and second magnet components, first and second links, first and second gears and a driving device set. By driving the movement of the first magnet component and the second magnet component respectively through the first link and the second link, it avoids the situation of using a steel cable to pull the magnet component to the extreme position and getting stuck, thereby avoiding the generation of noise and motor burnout. If there is a program failure in the upper control instrument, you only need to adjust the program.

### BACKGROUND AND SUMMARY OF THE INVENTION

The present invention relates to the technical field of fitness equipment, and in particular to an exercise bike flywheel system.

With the process of urbanization and the acceleration of people's pace of life, there is less and less space and time for exercise. More and more people are becoming more and more popular with advantages such as the way of riding a bicycle and the sports movements that do not harm the knee joints.

Exercise bikes in the prior art generally use a motor cable puller to control the gap between the magnet inside the flywheel and the aluminum brake disc to adjust the riding resistance, which is called electronically controlled adjustment of resistance. The specific principle is that the aluminum brake disc inside the flywheel is fixed together with the rotating flywheel to rotate synchronously. The magnet is close to the rotating aluminum brake disc, and its magnetic field causes changes in magnetic flux inside the aluminum brake disc to generate an induced current. The direction of the induced current will hinder the change in the original magnetic flux that causes the induced current. Under this action, the rotating aluminum brake disc will tend to stop due to resistance. If an external force is applied to the flywheel to drive the aluminum brake disc to continue to rotate, the induced current will form an eddy current loop inside the aluminum brake disc, converting the kinetic energy driving the aluminum brake disc to rotate into heat energy on the aluminum brake disc, completing the energy transform to achieve braking effect and achieve the purpose of controlling riding resistance. The smaller the gap between the magnet and the aluminum brake disc, the greater the change in magnetic flux on the aluminum brake disc, the greater the eddy current generated, and the stronger the flywheel resistance. On the contrary, the resistance of the flywheel is smaller. Normally, the motor cable puller is installed on the metal frame inside the exercise bike, and the reel of the motor cable puller is connected to the magnet bracket on the flywheel through a steel cable. The upper control instrument controls the reel to rotate to different angles, and the magnet bracket is tightened or released through the steel cable to achieve an adjustable gap between the magnet and the aluminum brake disc.

However, in actual use, it is often due to a program failure in the upper control instrument or an abnormality in the reel angle sensor of the motor cable puller that the motor cable reel rotation angle is too large. Thus, the maximum tolerance gap between the magnet inside the flywheel and the aluminum brake disc is exceeded and it gets stuck, causing noise and even causing the motor to burn out.

Therefore, the above-mentioned problems urgently need to be solved.

### SUMMARY OF THE INVENTION

In view of this, the inventor of the present invention finally created and designed this exercise bike flywheel system after continuous research, improvement and testing.

Therefore, the main object of the present invention is to provide an exercise bike flywheel system that can reduce or even avoid the situation where the motor cable puller reel in the existing exercise bike rotates at an excessively large angle and exceeds the maximum tolerance gap between the magnet inside the flywheel and the aluminum brake disc and gets stuck, causing noise and even the situation that causes the motor to burn out.

It is another object of the present invention is to provide an exercise bike flywheel system, in which if a program failure of the upper control instrument occurs, only the program of the upper control instrument needs to be adjusted. Exercise bikes that are equipped with the exercise bike flywheel system have low noise and the motor is not easy to burn out.

### BRIEF DESCRIPTION OF THE DRAWING

FIG. 1 is a schematic three-dimensional structural diagram of the exercise bike flywheel system of the present invention.

FIG. 2 is a schematic plan view of the exercise bike flywheel system of the present invention after removing the fixing member.

FIG. 3 is an enlarged view of part of FIG. 2.

### DETAILED DESCRIPTION OF THE INVENTION

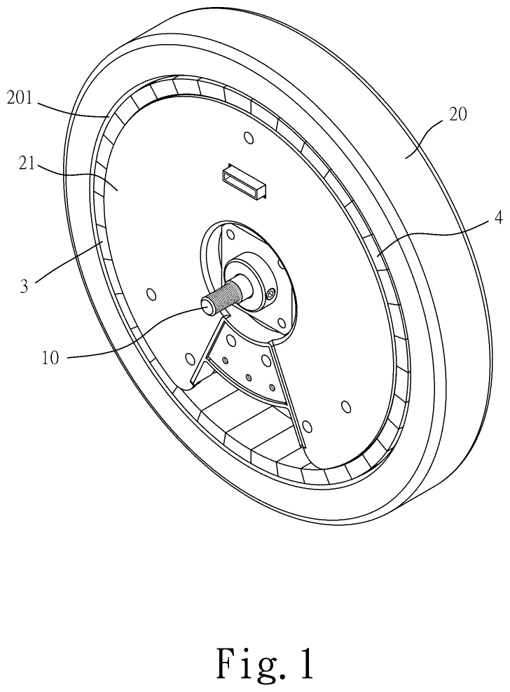

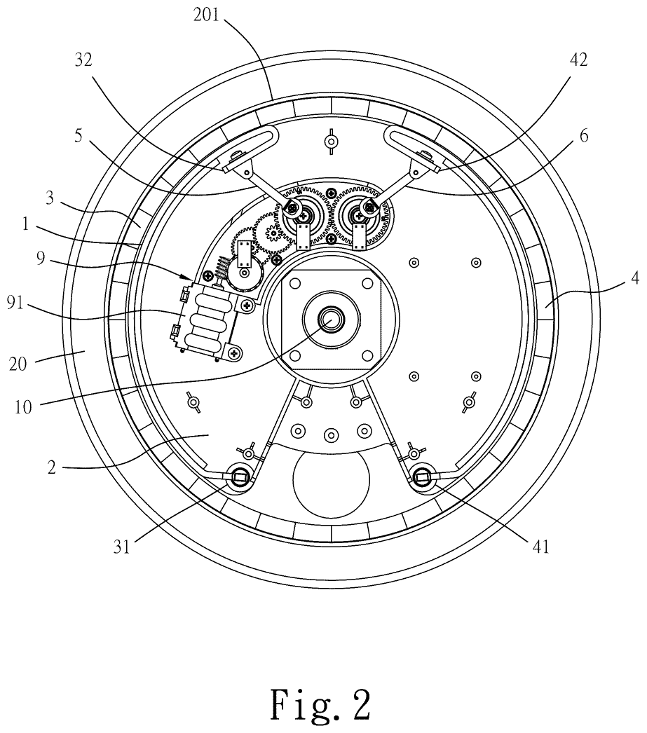

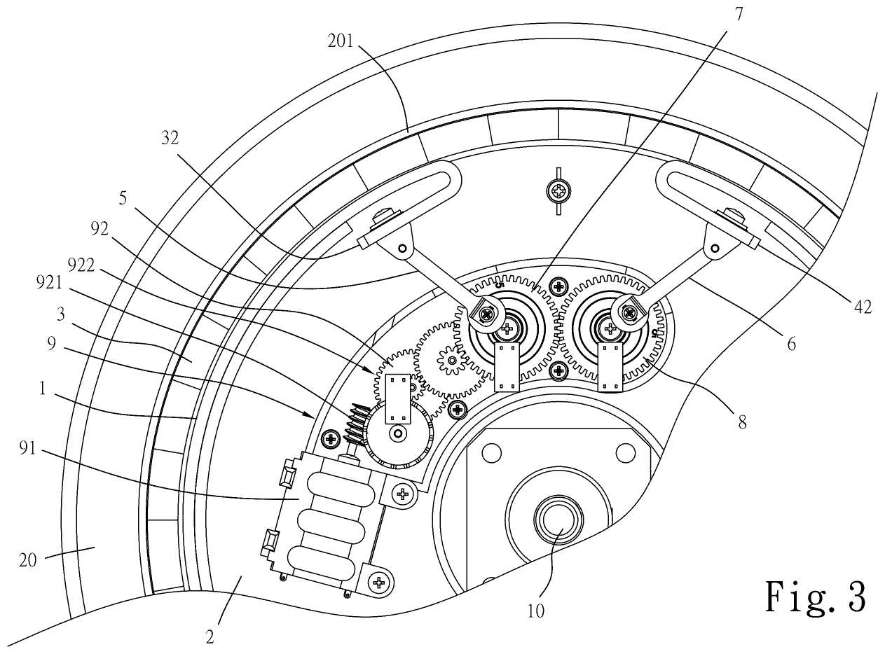

As shown in FIGS. 1 to 3, the embodiment of the present invention provides an exercise bike flywheel system, which comprises a rotating shaft 10, a flywheel 20, at least one brake component 1, a bracket 2, at least one magnet component such as a first magnet component 3 and a second magnet component 4, a first link 5, a second link 6, a first gear 7, a second gear 8 and a driving device set 9. The rotating shaft 10 is driven to rotate by the pedal mechanism on the exercise bike. The specific connection method is an existing technology and will not be described in detail in this embodiment. The flywheel 20 is fixedly connected to the rotating shaft 10, so that the user can drive the flywheel 20 to rotate through pedals to achieve the purpose of exercise.

The brake component 1 is arranged on the flywheel 20 along the circumferential direction of the flywheel 20. The bracket 2 is rotatably connected to the rotating shaft 10. The first magnet component 3 is arranged in an arc shape, and comprises a first fixed end 31 and a first movable end 32. The first fixed end 31 is rotatably set on bracket 2. The second magnet component 4 is arranged in an arc shape, and comprises a second fixed end 41 and a second movable end 42. The second fixed end 41 is rotatably set on bracket 2. The first magnet component 3 and the second magnet component 4 can cooperate to achieve similar shape of the brake component 1. One end of the first link 5 is fixedly connected to the first movable end 32. One end of the second link 6 is fixedly connected to the second movable end 42. Both the first gear 7 and the second gear 8 are rotatably mounted on the bracket 2. The first gear 7 and the second gear 8 turn in opposite directions. The first gear 7 comprises a first eccentric shaft. The other end of the first link 5 is rotatably connected to the first eccentric shaft. The second gear 8 comprises a second eccentric shaft. The other end of the first link 5 is rotatably connected to the second eccentric shaft.

It should be noted that in this embodiment, there are no specific requirements or restrictions on the positions of the first magnet component 3 and the second magnet component 4. The first magnet component 3 and the second magnet component 4 can be installed inside the flywheel 20 or on the outside of the flywheel according to the actual usage scenario. It can be understood that arranging the first magnet component 3 and the second magnet component 4 inside the flywheel 20 can make the structure of the flywheel system more compact, and enable certain components in the flywheel system to be shared, resulting in low cost and easy assembly. However, the parts in flywheel 20 need to be replaced, which will make the replacement workload heavy. Arranging the first magnet component 3 and the second magnet component 4 outside the flywheel 20 makes it easier to replace the components, but it will lead to high costs. In addition, it should be noted that the above-mentioned components used to drive the first magnet component 3 and the second magnet component 4 should also correspond to the position settings of the first magnet component 3 and the second magnet component 4, which will not be described in detail.

The driving device set 9 is configured to drive the first gear 7 and the second gear 8 to rotate at the same time, thereby ensuring the consistency of the rotation angles of the first gear 7 and the second gear 8. This can ensure the consistency of the spacing between the first magnet component 3 and the brake component 1 and the spacing between the second magnet component 4 and the brake component 1 to ensure a relatively linear braking effect.

In practical applications, the driving device set 9 drives the first gear 7 and the second gear 8 to rotate synchronously, that is, it can drive the first link 5 and the second link 6 to rotate synchronously at a certain angle. Then the first link 5 and the second link 6 drive the first magnet component 3 and the second magnet component 4 closer to or away from the brake component 1, thereby realizing the adjustment of the spacing between the first magnet component 3 and the brake component 1 and the spacing between the second magnet component 4 and the brake component 1, and further realizing adjustment of riding resistance.

It can be understood that in the above action, the first link 5 and the second link 6 drive the first magnet component 3 and the second magnet component 4 respectively, thereby effectively avoiding the problem in the prior art of using a steel cable to pull the magnet component to the extreme position will cause it to get stuck, thereby avoiding the generation of noise and the burning of the motor 91. It is also understandable that if a program failure occurs in the upper control instrument, only the program of the upper control instrument needs to be adjusted.

In a specific embodiment, the flywheel 20 comprises a circular receiving groove 201. The brake component 1 is fixedly arranged on the circumferential groove wall of the circular receiving groove 201, and the bracket 2 is located in the circular receiving groove 201, so that the first magnet component 3 and the second magnet component 4 and related components are located inside the flywheel 20. As a result, the structure of the flywheel system can be made more compact, and certain components in the flywheel system can be shared, resulting in low cost and easy assembly. In this embodiment, the brake component 1 is an annular aluminum sheet, and the annular aluminum sheet is adhered to the circumferential groove wall of the circular receiving groove 201. It can be understood that the use cost of annular aluminum sheet is low.

To further improve the compactness of the flywheel system, the driving device set 9 is installed on the bracket 2.

Specifically, the first gear 7 meshes with the second gear 8. The driving device set 9 comprises a motor 91 and a transmission gear set 92. The motor 91 is arranged on the bracket 2. The first gear 7 or second gear 8 and the motor 91 are transmitted through the transmission gear set 92. It can be understood that because the first gear 7 and the second gear 8 are meshed, that is, by driving either the first gear 7 or the second gear 8, the first gear 7 and the second gear 8 can rotate synchronously. This makes the structure of the flywheel system more compact and can ensure the consistency of the rotation of the first gear 7 and the second gear 8. In addition, because the first gear 7 and the second gear 8 are directly meshed, it can ensure that the two directions are always opposite.

Further, the transmission gear set 92 comprises a worm 921 and a plurality of intermediate gears 922. The worm 921 is coaxially fixed on the output shaft of the motor 91. The plurality of intermediate gears 922 engage and transmit one by one to form a transmission path arranged along a preset direction. The worm 921 meshes with the intermediate gear 922 located at the beginning of the transmission path, and the first gear 7 or second gear 8 meshes with the intermediate gear 922 located at the end of the transmission path. It can be understood that using the transmission method of worm 921 can make the driving device set 9 have the advantages of high transmission efficiency, low noise and long service life. It should be noted that the intermediate gears 922 located at the starting end of the transmission path are fixedly provided with a worm gear that matches the worm 921. It should also be noted that in this embodiment, the number of intermediate gears 922 is three. In other embodiments, the number of intermediate gears 922 may also be five, seven or more.

In some embodiments, the flywheel system also comprises an angle sensor (not shown in the figure). The angle sensor is used to detect the rotation angle of the first gear 7 or the second gear 8, so as to more accurately control the spacing between the magnet and the brake component 1. It should be noted that the angle sensor can preferably be a photoelectric sensor in the prior art, which will not be described again. In addition, the installation position of the angle sensor can be selected according to the actual application scenario, such as in the driving device set 9 mentioned above. Using an angle sensor to detect the rotation angle of the first gear 7, the second gear 8 or any intermediate gear 922, the rotation angle of the first gear 7 and the second gear 8 can be obtained.

In some embodiments, the flywheel system also comprises a fixing member 21 that is rotationally connected to the rotating shaft 10. The fixing member 21 is configured to cooperate with the bracket 2 to fix the components located on the bracket 2, thereby helping to ensure the stability of the flywheel system. It should be noted that the matching method between the fixing member 21 and the bracket 2 can be any convenient implementation method such as snap connection or screw connection.

Furthermore, the fixing member 21 can seal the slot of the circular receiving groove 201, thereby protecting the internal components of the flywheel 20 and helping to improve the aesthetics.

Using the exercise bike of this embodiment, the practicality of making the exercise bike low in noise and making the motor 91 less likely to burn out can be achieved.

In summary, the present invention can be summarized as having the following industrial utilization values:

1. It can reduce or even avoid the situation where the motor cable puller reel in the existing exercise bike rotates at an excessively large angle and exceeds the maximum tolerance gap between the magnet inside the flywheel and the aluminum brake disc and gets stuck, causing noise and even the situation that causes the motor to burn out.

2. If there is a program failure in the upper control instrument, you only need to adjust the program of the upper control instrument. Exercise bikes that are equipped with the exercise bike flywheel system have low noise and the motor is not easy to burn out.

What is claimed is:

1. An exercise bike flywheel system, comprising:
a rotating shaft;
a flywheel fixedly connected to said rotating shaft;
at least one brake component provided on said flywheel along the circumferential direction of said flywheel;
a bracket rotationally connected to said rotating shaft;
a first magnet component arranged in an arc shape, said first magnet component comprising a first fixed end and a first movable end, said first fixed end being rotatably arranged on said bracket;
a second magnet component arranged in an arc shape, said second magnet component comprising a second fixed end and a second movable end, said second fixed end being rotatably arranged on said bracket, said second magnet component cooperating with said first magnet component to achieve a shape similar to said brake component;
a first gear and a second gear both rotatably arranged on said bracket, said first gear and said second gear rotating in opposite directions, said first gear comprising a first eccentric shaft, said second gear comprising a second eccentric shaft;
a first link and a second link, said first link having one end thereof fixedly connected to said first movable end and an opposite end thereof rotationally connected to said first eccentric shaft, said second link having one end thereof fixedly connected to said second movable end and an opposite end thereof rotationally connected to said second eccentric shaft; and
a driving device set configured to drive said first gear and said second gear to rotate simultaneously.

2. The exercise bike flywheel system as claimed in claim 1, wherein said flywheel comprises a circular receiving groove; said at least one brake component is fixedly arranged on the circumferential groove wall of said circular receiving groove; said bracket is located in said circular receiving groove; said driving device set is arranged on said bracket.

3. The exercise bike flywheel system as claimed in claim 2, wherein said first gear meshes with said second gear; said driving device set comprising a motor and a transmission gear set, said motor being set on said bracket so that said first gear or said second gear and said motor are transmitted through said transmission gear set.

4. The exercise bike flywheel system as claimed in claim 3, wherein said transmission gear set comprises a worm and a plurality of intermediate gears, said worm being coaxially fixed on the output shaft of said motor, said multiple intermediate gears meshing and transmitting one by one to form a transmission path set in a preset direction, said worm meshing with the said intermediate gear located at the beginning of said transmission path, said first gear or said second gear meshing with the said intermediate gear located at the end of said transmission path.

5. The exercise bike flywheel system as claimed in claim 1, further comprising an angle sensor used to detect the rotation angle of said first gear or said second gear.

6. The exercise bike flywheel system as claimed in claim 2, further comprising a fixing member rotationally connected to said rotating shaft, said fixing member is configured to cooperate with said bracket to fix the components located on said bracket and to seal said circular receiving groove.

7. The exercise bike flywheel system as claimed in claim 2, wherein said brake component is an annular aluminum sheet adhered to the circumferential groove wall of said circular receiving groove.
